(19) United States
(12) Patent Application Publication
(10) Pub. No.: US 2008/0113245 A1
(43) Pub. Date: May 15, 2008

(54) METHOD OF MAKING HYDROPHILIC FUEL CELL BIPOLAR PLATES

(75) Inventors: Ping Liu, Irvine, CA (US); Tao Xie, Troy, MI (US); Mahmoud H. Abd Elhamid, Grosse Pointe Woods, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/558,076

(22) Filed: Nov. 9, 2006

(51) Int. Cl. H01M 8/02; B01J 19/08

(52) U.S. Cl. 429/34; 427/115; 205/687; 977/742

(57) ABSTRACT

A process of one embodiment of the invention includes providing a fuel cell bipolar plate comprising carbon exposed at an outer surface of the bipolar plate and reacting a diazonium salt with the exposed carbon so that a functional group is attached to the exposed carbon to increase the hydrophilicity of the bipolar plate where the functional group is attached.

### TECHNICAL FIELD

The field to which the disclosure generally relates includes methods of making a fuel cell bipolar plate and a bipolar plate including carbon and a hydrophilic group bonded to the carbon and products including the same.

### BACKGROUND

Hydrogen is a very attractive fuel because it is clean and can be used to efficiently produce electricity in a fuel cell. The automotive industry has committed significant resources in the development of hydrogen fuel cells as a source of power for vehicles. Such vehicles would be more efficient and generate fewer emissions than today's vehicles employing internal combustion engines.

A hydrogen fuel cell is an electro-chemical device that includes an anode and a cathode with an electrolyte therebetween. The anode receives hydrogen-rich gas or pure hydrogen and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work may be used to operate a vehicle, for example.

Proton exchange membrane fuel cells (PEMFC) are popular for vehicle applications. The PEMFC generally includes a solid-polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. For the automotive fuel cell stack mentioned above, the stack may include about two hundred or more bipolar plates. The fuel cell stack receives a cathode reactant gas, typically a flow of air forced through the stack by a compressor. Not all of the oxygen is consumed by the stack and some of the air is output as a cathode exhaust gas that may include liquid water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of the MEA. Cathode gas flow channels are provided on the cathode side of the bipolar plates that allow the cathode gas to flow to the cathode side of the MEA. The bipolar plates may also include flow channels for a cooling fluid.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, this oxide layer is not conductive, and thus increases the internal resistance of the fuel cell, reducing its electrical performance. Also, the oxide layer frequently makes the plates more hydrophobic.

US Patent Application Publication No. 2003/0228512, assigned to the assignee of this application, discloses a process for depositing a conductive outer layer on a flow field plate that prevents the plate from oxidizing and increasing its ohmic contact. U.S. Pat. No. 6,372,376, also assigned to the assignee of this application, discloses depositing an electrically conductive, oxidation resistant and acid resistant coating on a flow field plate. US Patent Application Publication No. 2004/0091768, also assigned to the assignee of this application, discloses depositing a graphite and carbon black coating on a flow field plate for making the flow field plate corrosion resistant, electrically conductive and thermally conductive.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², water accumulates within the flow channels because the flow rate of the reactant gas is too low to force the water out of the channels. As the water accumulates, it forms droplets that continue to expand because of the hydrophobic nature of the plate material. The contact angle of the water droplets is generally about 90° in that the droplets form in the flow channels substantially perpendicular to the flow direction of the reactant gas. As the size of the droplets increases, the flow channel is closed off, and the reactant gas is diverted to other flow channels because the channels flow in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the cathode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It has been proposed by the present inventors to make bipolar plates for a fuel cell hydrophilic to improve channel water transport. A hydrophilic plate causes water in the channels to spread along the surface in a process termed spontaneous wetting. The resulting thin film has less of a tendency to alter the flow distribution along the array of channels connected to the common inlet and outlet headers. If the plate material has sufficiently high surface energy, water transport through the diffusion media will contact the channel walls and then, by capillary force, be transported into the bottom corners of the channel along its length. The physical requirements to support spontaneous wetting in the corners of a flow channel are described by the Concus-Finn condition,

$$β + \frac{α}{2} < 90 \underline{°}$$

where β is the static contact angle formed between a liquid surface and solid surface, and α is the channel corner angle. For a rectangular channel α/2=45°, which dictates that spontaneous wetting will occur when the static contact angle is less than 45°. For the roughly rectangular channels used in certain fuel cell stack designs with composite bipolar plates, such design sets an approximate upper limit on the contact angle needed to realize the beneficial effects of hydrophilic plate surfaces on channel water transport and low load stability.

### SUMMARY OF EXEMPLARY EMBODIMENTS OF THE INVENTION

One embodiment of the invention includes a process including providing a fuel cell bipolar plate including carbon and reacting a diazonium salt with the carbon so that a functional group is attached to the carbon thereby increasing the hydrophilicity of the bipolar plate.

Another embodiment of the invention includes providing a bipolar plate comprising a polymer and a filler material comprising carbon and wherein the polymer forms a skin over the filler material and so that the filler is not exposed at the surface of the plate. The bipolar plate is treated to expose at least a portion of the filler material comprising carbon, and the exposed carbon is reacted with a diazonium salt with the carbon so that a functional group is attached to the carbon thereby increasing the hydrophilicity of the bipolar plate.

Another embodiment of the invention includes providing a bipolar plate comprising a substrate comprising metal and a coating comprising carbon over the substrate, and reacting a diazonium salt with the carbon so that a functional group is attached to the carbon thereby increasing the hydrophilicity of the bipolar plate.

Another embodiment of the invention includes providing a substrate comprising carbon, and reacting a diazonium salt with the carbon so that a functional organic group is attached to the carbon thereby increasing the hydrophilicity of the substrate, and thereafter forming the substrate into at least a portion of a fuel cell bipolar plate.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates a fuel cell composite bipolar plate according to one embodiment of the invention.

FIG. 2 illustrates an enlarged, sectional view of a portion of a composite bipolar plate including a filler material comprising carbon useful in a method according to one embodiment of the invention.

FIG. 3 illustrates a method of treating a fuel cell composite bipolar plate including a filler material comprising carbon according to one embodiment of the invention.

FIG. 4 illustrates a fuel cell bipolar plate including a coating comprising carbon having functional groups attached thereto according to one embodiment of the invention.

FIG. 5 illustrates a method including selectively treating portions of a fuel cell bipolar plate including carbon.

FIG. 6 illustrates a fuel cell bipolar plate including carbon having been treated to attach functional groups thereto according to one embodiment of the invention.

FIG. 7 illustrates a method of treating a substrate comprising carbon to attach functional groups thereto according to one embodiment of the invention.

FIG. 8 illustrates a portion of a fuel cell bipolar plate including carbon treated to attach functional groups thereto according to one embodiment of the invention.

FIG. 9 illustrates a portion of a fuel cell stack including a bipolar plate comprising carbon treated to attach functional groups thereto according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

One embodiment of the invention includes providing a fuel cell bipolar plate including carbon exposed at a surface of the bipolar plate. Functional groups are attached to the exposed carbon to increase the hydrophilicity of the bipolar plate (i.e., make the bipolar plate more hydrophilic). In one embodiment of the invention, the exposed carbon is reacted with a diazonium salt. FIG. 1 illustrates one embodiment of a product 10 which may be a composite bipolar plate that includes a filler material comprising carbon. A portion of the filler material comprising carbon is exposed at a surface 12 of the bipolar plate 10. The exposed carbon includes functional groups attached thereto that increase the hydrophilic nature of the surface of the bipolar plate at the location of the functional groups. The functional groups may be attached to the carbon in the filler material, for example, by reacting the carbon with a diazonium salt. The filler material may include macroparticles, nanoparticles, fibers, nanofibers, nanotubes which may be completely carbon or graphite. Alternatively, at least a portion of the filler material includes carbon or graphite.

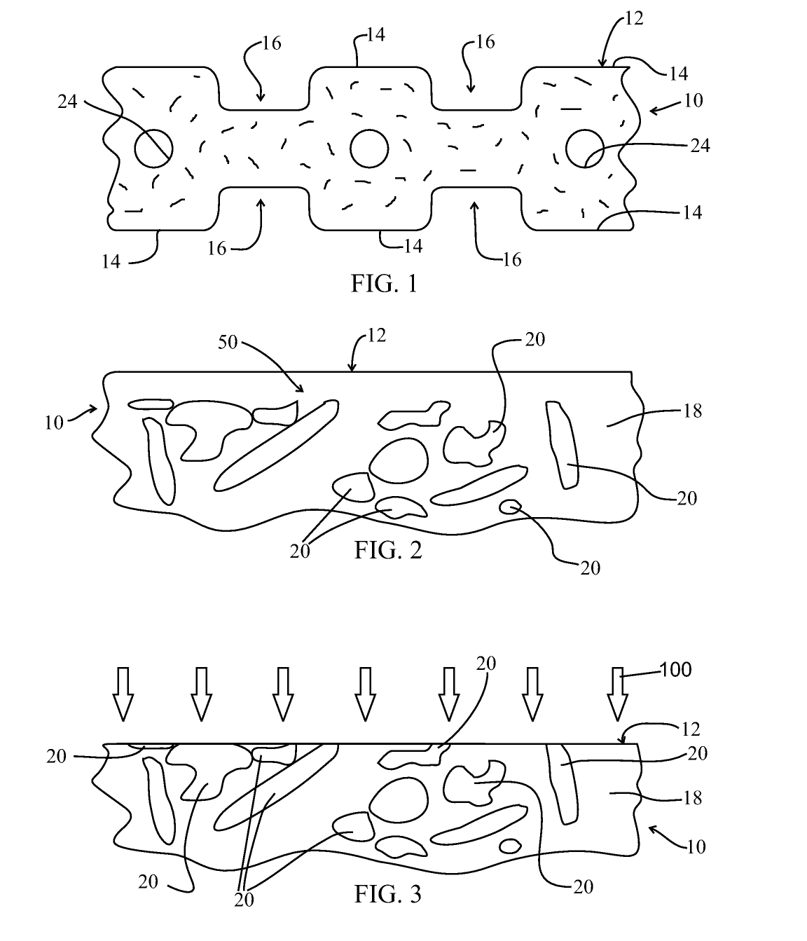

Referring now to FIG. 2, one embodiment of the invention includes providing a bipolar plate 10 made from a composite material including a polymer 18 and a filler material 20 including carbon. The composite bipolar plate 10 may be produced using a molding process which leaves a skin 50 of the polymeric material 18 encasing the filler material 20 such that the filler material 20 is not exposed at the outer surface 12 of the composite bipolar plate 10.

FIG. 3 illustrates one embodiment of the invention including removing the skin 50 from the composite bipolar plate of FIG. 2 to expose at least a portion of the filler material 20 including carbon so that the bipolar plate 10 includes an outer surface 12 including exposed carbon. The skin 50 may be removed 100 by machining, wet or dry etching, ion bombardment or the like. The exposed carbon at the outer surface 12 is then reacted with a compound such as a diazonium salt to attach functional groups to the exposed carbon. As such, only the carbon at the outer surface 12 has functional groups attached thereto. This embodiment of the invention eliminates the need to treat or react all of the filler material 20 in the composite material prior to forming the composite bipolar plate by a subsequent molding process.

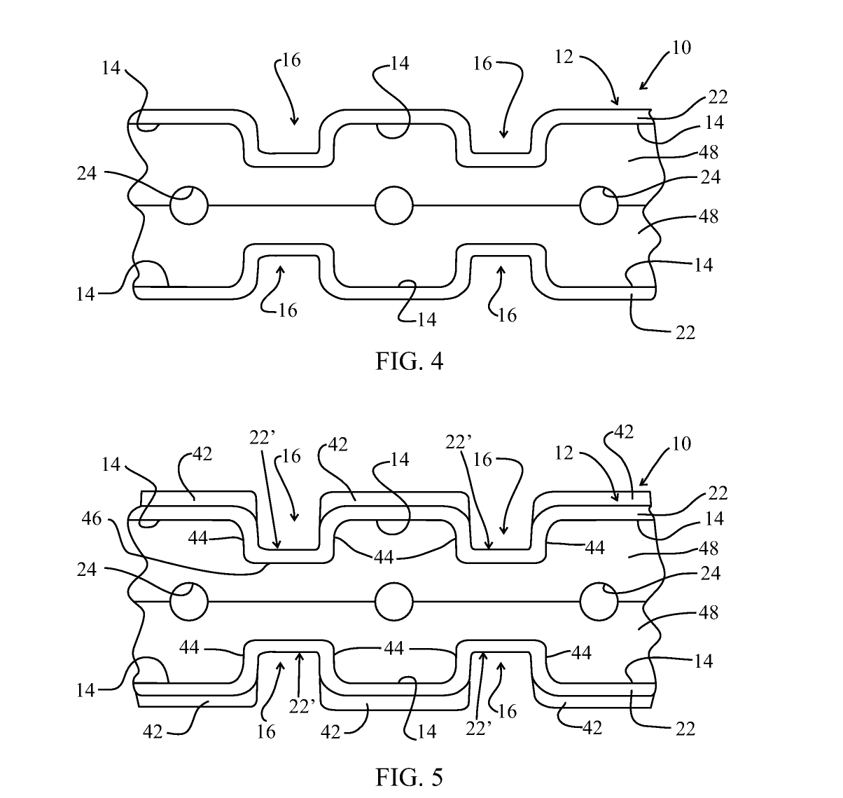

Referring now to FIG. 4, one embodiment of the invention includes a bipolar plate 10 including at least one, and typically two, substrates 48. The substrates 48 may comprise metal or a metal alloy such as, but not limited to, aluminum for stainless steel. A coating 22 is provided over at least a portion of the bipolar plate 10. The coating 22 includes carbon. The carbon in the coating 22 is reacted with a compound such as a diazonium salt to attach functional groups to the carbon to increase the hydrophilicity of the bipolar plate. The carbon may be present in the coating in the form of carbon-based polymers or in the form of a filler material comprising carbon. The bipolar plate 10 includes a plurality of lands 14 and channels 16 defining a reactant gas flow field. The coating 22 may be deposited over the entire surface of the bipolar plate including the lands 14 and channels 16, or the coating 22 may be selectively deposited over portions of the bipolar plate, for example, over only the channels 16.

Referring now to FIG. 5, in one embodiment of the invention, a masking material 42 may be selectively deposited over portions of a fuel cell bipolar plate 10, for example, over the lands 14, leaving the channels 16, defined by side walls 44 and bottom wall 46 exposed. The exposed portion 22′ of the coating 22 may be reacted with a compound such as a diazonium salt to attach functional groups to exposed carbon of the coating 22. Similarly, a mask 42 may be selectively deposited, for example, over the lands 14 of a composite bipolar plate and thereafter, the exposed portions of the composite bipolar plate are reacted with a compound such as a diazonium salt to attach functional groups to exposed carbon. The functional groups increase the hydrophilicity of the bipolar plate in selected areas, such as the channels.

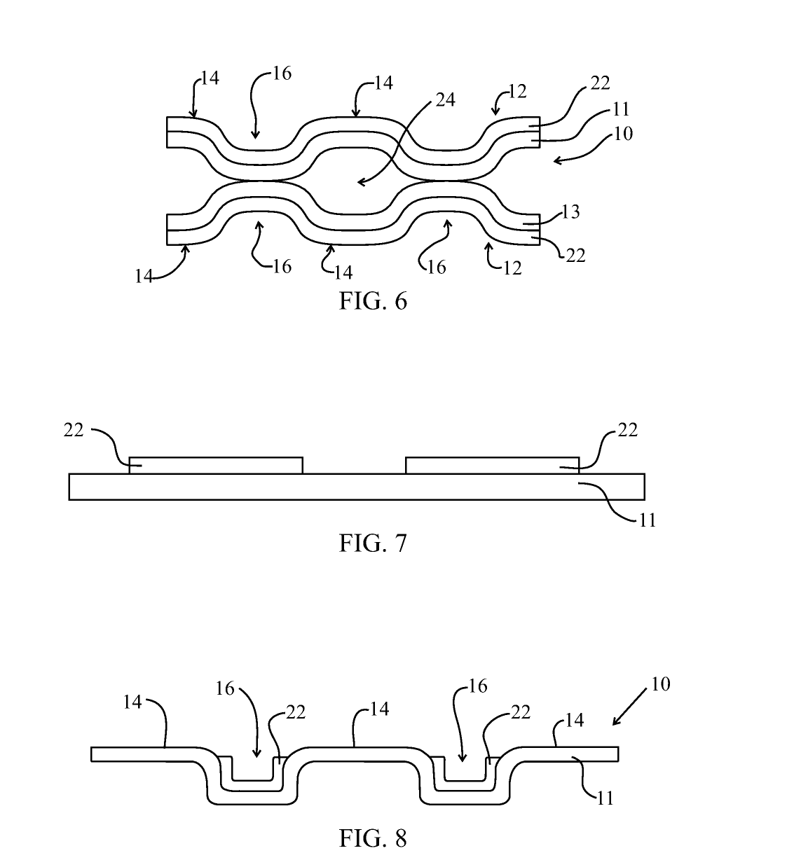

Referring now to FIG. 6, in another embodiment of the invention, a bipolar plate 10 may be made from stamped metal sheets 11, 13 wherein each sheet 11, 13 may have a coating 22 thereon. The coating 22 is reacted with a compound such as a diazonium salt to attach functional groups to the carbon of the coating 22.

Referring now to FIG. 7, another embodiment of the invention includes providing a substrate 11 comprising a metal and selectively depositing a coating 22 on the substrate 11. The coating 22 includes carbon. The carbon is reacted with a compound such as a diazonium salt to attach functional groups to the carbon to increase the hydrophilicity of the substrate at the location of the coating 22. Thereafter, as shown in FIG. 8, the substrate 11 may be formed into a structure including a plurality of lands 14 and channels 16 wherein the coating 22 is selectively located in the channels 16. The product 10 shown in FIG. 8 may be used to form a bipolar plate.

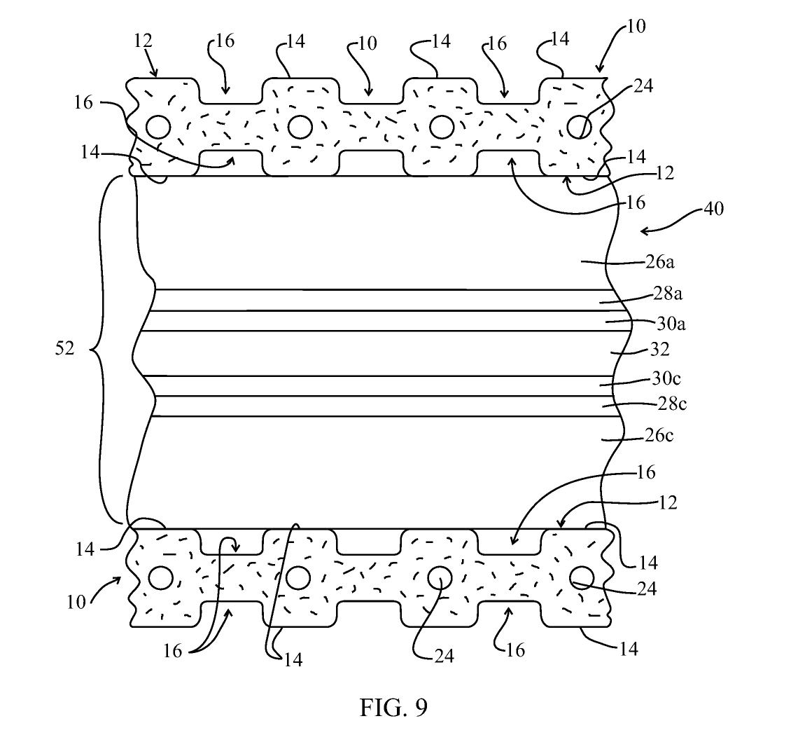

Referring now to FIG. 9, two spaced apart bipolar plates 10 are provided and a soft goods portion 52 is provided therebetween. Each bipolar plate 10, such as a composite plate, includes a filler material comprising carbon. A portion of the filler material at an outer surface 12 of the bipolar plate 10 is reacted with a compound such as a diazonium salt to attach functional groups to the carbon. The soft goods portion 52 may include a polyelectrolyte membrane 32 having a first electrode 30a, such as an anode, overlying the polyelectrolyte membrane 32. A microporous layer 28a may overlie the first electrode 30a, and a first gas diffusion media layer 26a may overlie the first microporous layer 28a. Similarly, a second electrode 30c, such as a cathode, may underlie the polyelectrolyte membrane 32. A second microporous layer 28c may underlie the second electrode 30c and a second gas diffusion media layer 26c may underlie the second microporous layer 28c.

The reaction between a diazonium salt and a carbonation forms a product having an organic group attached to the carbonation. The diazonium salt may contain the organic group to be attached to the carbon atom.

The organic group may be an aliphatic group, a cyclic organic group, or an organic compound having an aliphatic portion and a cyclic portion. The diazonium salt may be derived from a primary amine having one of these groups and being capable of forming, even transiently, a diazonium salt. The organic group may be substituted or unsubstituted, branched or unbranched. Aliphatic groups include, for example, groups derived from alkanes, alkenes, alcohols, ethers, aldehydes, ketones, carboxylic acids, and carbohydrates. Cyclic organic groups include, but are not limited to, alicyclic hydrocarbon groups (for example, cycloalkyls, cycloalkenyls), heterocyclic hydrocarbon groups (for example, pyrrolidinyl, pyrrolinyl, piperidinyl, morpholinyl, and the like), aryl groups (for example, phenyl, naphthyl, anthracenyl, and the like), and heteroaryl groups (imidazolyl, pyrazolyl, pyridinyl, thienyl, thiazolyl, furyl, indolyl, and the like). As the steric hindrance of a substituted organic group increases, the number of organic groups attached to the carbon from the reaction between the diazonium salt and the carbon may be diminished.

When the organic group is substituted, it may contain any functional group compatible with the formation of a diazonium salt. Preferred functional groups include, but are not limited to, R, OR, COR, COOR, OCOR, carboxylate salts such as COOLi, COONa, COOK, COO⁻NR₄⁺, halogen, CN, NR₂, SO₃H, sulfonate salts such as SO₃Li, SO₃Na, SO₃K, SO₃⁻NR₄⁺, OSO₃H, OSO₃⁻ salts, NR(COR), CONR₂, NO₂, PO₃H₂, phosphonate salts such as PO₃HNa and PO₃Na₂, phosphate salts such as OPO₃HNa and OPO₃Na₂, N═NR, NR₃⁺X⁻, PR₃⁺X⁻, SₖR, SSO₃H, SSO₃⁻ salts, SO₂NRR′, SO₂SR, SNRR′, SNQ, SO₂NQ, CO₂NQ, S-(1,4-piperazinediyl)-SR, 2-(1,3-dithianyl)2-(1,3-dithiolanyl), SOR, and SO₂R. R and R′, which can be the same or different, are independently hydrogen, branched or unbranched C₁-C₂₀ substituted or unsubstituted, saturated or unsaturated hydrocarbon, e.g., alkyl, alkenyl, alkynyl, substituted or unsubstituted aryl, substituted or unsubstituted heteroaryl, substituted or unsubstituted alkylaryl, or substituted or unsubstituted arylalkyl. The integer k ranges from 1-8 and preferably from 2-4. The anion X⁻ is a halide or an anion derived from a mineral or organic acid. Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6.

In one embodiment of the invention, the organic group is an aromatic group of the formula A_{y}Ar—, which corresponds to a primary amine of the formula A_{y}ArNH₂. In this formula, the variables have the following meanings: Ar is an aromatic radical such as an aryl or heteroaryl group. Preferably, Ar is selected from the group consisting of phenyl, naphthyl, anthracenyl, phenanthrenyl, biphenyl, pyridinyl, benzothiadiazolyl, and benzothiazolyl; A is a substituent on the aromatic radical independently selected from a preferred functional group described above or A is a linear, branched or cyclic hydrocarbon radical (preferably containing 1 to 20 carbon atoms), unsubstituted or substituted with one or more of those functional groups; and y is an integer from 1 to the total number of —CH radicals in the aromatic radical. For instance, y is an integer from 1 to 5 when Ar is phenyl, 1 to 7 when Ar is naphthyl, 1 to 9 when Ar is anthracenyl, phenanthrenyl, or biphenyl, or 1 to 4 when Ar is pyridinyl. In the above formula, specific examples of R and R′ are NH₂—C₆H₄—, CH₂ CH₂—C₆H₄—NH₂, CH₂—C₆H₄—NH₂, and C₆H₅.

Another preferred set of organic groups which may be attached to the carbon are organic groups substituted with an ionic or an ionizable group as a functional group. An ionizable group is one which is capable of forming an ionic group in the medium of use. The ionic group may be an anionic group or a cationic group and the ionizable group may form an anion or a cation. Ionizable functional groups forming anions include, for example, acidic groups or salts of acidic groups. The organic groups, therefore, include groups derived from organic acids. Preferably, when it contains an ionizable group forming an anion, such an organic group has a) an aromatic group and b) at least one acidic group having a pKa of less than 11, or at least one salt of an acidic group having a pKa of less than 11, or a mixture of at least one acidic group having a pKa of less than 11 and at least one salt of an acidic group having a pKa of less than 11. The pKa of the acidic group refers to the pKa of the organic group as a whole, not just the acidic substituent. More preferably, the pKa is less than 10 and most preferably less than 9. Preferably, the aromatic group of the organic group is directly attached to the carbon. The aromatic group may be further substituted or unsubstituted, for example, with alkyl groups. More preferably, the organic group is a phenyl or a naphthyl group and the acidic group is a sulfonic acid group, a sulfanic acid group, a phosphonic acid group, or a carboxylic acid group. Examples of these acidic groups and their salts are discussed above. Most preferably, the organic group is a substituted or unsubstituted sulfophenyl group or a salt thereof; a substituted or unsubstituted (polysulfo)phenyl group or a salt thereof; a substituted or unsubstituted sulfonaphthyl group or a salt thereof; or a substituted or unsubstituted (polysulfo)naphthyl group or a salt thereof. A preferred substituted sulfophenyl group is hydroxysulfophenyl group or a salt thereof.

Specific organic groups having an ionizable functional group forming an anion (and their corresponding primary amines for use in a process according to the invention) are p-sulfophenyl (p-sulfanilic acid), 4-hydroxy-3-sulfophenyl (2-hydroxy-5-amino-benzenesulfonic acid), and 2-sulfoethyl (2-aminoethanesulfonic acid).

Amines represent examples of ionizable functional groups that form cationic groups. For example, amines may be protonated to form ammonium groups in acidic media. Preferably, an organic group having an amine substituent has a pKb of less than 5. Quaternary ammonium groups (—NR₃⁺) and quaternary phosphonium groups (—PR₃⁺) also represent examples of cationic groups. Preferably, the organic group contains an aromatic group such as a phenyl or a naphthyl group and a quaternary ammonium or a quaternary phosphonium group. The aromatic group is preferably directly attached to the carbon. Quaternized cyclic amines, and even quaternized aromatic amines, can also be used as the organic group. Thus, N-substituted pyridinium compounds, such as N-methyl-pyridyl, can be used in this regard. Examples of organic groups include, but are not limited to, (C₅H₄N)C₂H₅⁺, C₆H₄ (NC₅H₅)⁺, C₆H₄COCH₂N(CH₃)₃⁺, C₆H₄COCH₂(NC₅H₅)⁺, (C₅H₄N)CH₃⁺, and C₆H₄CH₂N(CH₃)₃⁺.

The bipolar plate may comprise a composite material. The composite material may include at least one of an epoxy, polyvinyl ester, polyester, polypropylene or polyvinylidene fluoride (PVDF) polymer. The filler material may be present in about 10% to about 50% by volume of the composite material.

In one embodiment wherein the bipolar plate includes a coating including carbon, the coating 22 may be an electrically-conductive, oxidation resistant, and acid-resistant protective material having a resistivity less than about 50 ohm-cm, and comprising a plurality of oxidation-resistant, acid-insoluble, conductive particles (i.e. less than about 50 microns) dispersed throughout an acid-resistant, oxidation-resistant polymer matrix. The conductive filler particles may include graphite or carbon. Additional conductive filler particles may include gold, platinum, palladium, rhodium, ruthenium, and the rare earth metals. Most preferably, the particles will comprise conductive carbon and graphite at a loading of about 5 to about 50 and most preferably about 10% by weight. The polymer matrix comprises any water-insoluble polymer that can be formed into a thin adherent film and that can withstand the hostile oxidative and acidic environment of the fuel cell. Hence, such polymers, as epoxies, polyamide-imides, polyether-imides, polyphenols, fluro-elastomers (e.g., polyvinylidene flouride), polyesters, phenoxy-phenolics, epoxide-phenolics, acrylics, and urethanes, inter alia are seen to be useful with the composite coating. Cross-linked polymers are preferred for producing impermeable coatings, with polyamide-imide thermosetting polymers being most preferred. To apply the polymer composite layer, the polyamide-imide is dissolved in a solvent comprising a mixture of N-methylpyrrolidone, propylene glycol and methyl ether acetate, and about 21% to about 23% by weight of a mixture of graphite and carbon black particles added thereto. The graphite particles range in size from about 5 microns to about 20 microns and the carbon black particles range in size from about 0.5 micron to about 1.5 microns. The mix is sprayed on to the substrate, dried (i.e. solvent vaporized), and cured to provide 15-30 micron thick coating (preferably about 17 microns) having a carbon-graphite content of about 38% by weight. It may be cured slowly at low temperatures (i.e. <400° F.), or more quickly in a two step process wherein the solvent is first removed by heating for ten minutes at about 300° F.-350° F. (i.e., dried) followed by higher temperature heating (500° F.-750° F.) for various times ranging from about ½ min to about 15 min (depending on the temperature used) to cure the polymer.

### EXAMPLE 1

The diazonium salt was prepared using a sulfanilic acid which was dissolved in a sodium carbon solution to increase the concentration of the active dissolved species in the solution. A known amount of sodium nitride was added to the sodium salt solution of the sulfanilic acid. Subsequently, the solution was transferred to an ice/water bath where the temperature was kept at 0° C. Hydrochloric acid was then added to the cold solution to form nitrous acid and to form the diazonium salt of the sulfanilic acid thereafter. A polished carbon composite sample was then immersed in the diazonium salt solution and the temperature of the solution was then allowed to increase gradually to room temperature by removing the diazonium salt from the ice bath. Gas bubbles (nitrogen) were seen coming from the solution which is an indication of the decomposition of the diazonium salt and the subsequent attachment of the aryl radical to the carbon composite sample through the free radical mechanism. The contact angle measured on the composite sample after the process was <300 which is to be compared to >1000 before the experiments. No apparent effect of temperature was seen on the sample after keeping it at 90° C. for 24 hours in an open air atmosphere.

### EXAMPLE 2

In an electrochemical cell, 5 mM of p-sulfonic pheyldiazonium tetrafluoroborate (p-SO₃H—C₆H₄—N₂⁺BF₄⁻) dissolved in a pH7 buffer solution serves as the electrolyte. A graphite plate, cleaned with isopropanol and water, serves as the working electrode, while a platinum wire and a Ag/AgCl electrode act as counter and reference electrodes, respectively. At room temperature (20° C.), a constant potential of −0.75 V is applied to the working electrode for 600 s. The electrode is washed with water and methanol followed by sonication for ˜10 min and rinsed again with water. The carbon plate is stored at 90° C. in air and the contact angle is measured periodically. The contact angle was ˜100 after treatment and remained that way after 20 days. In comparison, the untreated plate has a contact angle of 87°.

### EXAMPLE 3

In the experiment, a composite plate was treated in the same manner as the graphite plate in Example 2. The composite plate was polished with a sand paper to expose the graphite particle surfaces. The contact angle after treatment is 320 and remains at that value after 8 days. In comparison, the untreated plate has a contact angle of 840.

Additional embodiments of the current inventions are possible. Hydrophilic groups as exemplified by sulfonic acid may include other ionizable/ionic groups such as carboxylic acids and tetraalkylammonium salts as well as nonionic hydrophilic groups such as oligomers of ethylene glycols. Most preferably, inorganic function groups are to be used because they are not prone to oxidation or reduction under the cathodic or the anodic potential conditions seen inside the fuel cell.

Attachment to the carbon surface can be done via a variety of ways. For example, oxidation of amines, carboxylic acids and alcohols can all provide mechanisms for surface modification which is discussed in detail in A. J. Downard, Electroanalysis, 2000, 14, 12.

The above description of embodiments of the invention is merely exemplary in nature and, thus, variations thereof are not to be regarded as a departure from the spirit and scope of the invention.

What is claimed is:

1. A process comprising:
providing a fuel cell bipolar plate comprising carbon exposed at an outer surface of the bipolar plate and reacting a diazonium salt with the exposed carbon so that a functional group is attached to the exposed carbon to increase the hydrophilicity of the bipolar plate where the functional group is attached.

2. A process as set forth in claim 1 wherein the diazonium salt is derived from a sulfanilic acid.

3. A process as set forth in claim 1 wherein the diazonium salt comprises p-SO₃H—C₆H₄—N₂⁺BF₄⁻.

4. A process as set forth in claim 1 wherein the bipolar plate is a composite plate comprising a polymer and a filler material comprising the carbon.

5. A process as set forth in claim 4 wherein the filler material comprises at least one of macroparticles, nanoparticles, fibers, nanofibers or nanotubes.

6. A process as set forth in claim 4 wherein the filler material comprises graphite.

7. A process as set forth in claim 1 wherein the bipolar plate comprises a substrate comprising a metal or metal alloy, and a coating over the substrate, and wherein the coating comprises the carbon.

8. A process as set forth in claim 1 wherein the bipolar plate is a substrate comprising a metal or metal alloy, and a coating over the substrate, and wherein the coating comprising a polymer and a filler material, and wherein the filler material comprises the carbon.

9. A process as set forth in claim 8 wherein the filler material comprises at least one of macroparticles, nanoparticles, fibers, nanofibers or nanotubes.

10. A process as set forth in claim 1 further comprising providing a composite bipolar plate comprising a polymer and a filler material comprising carbon, and wherein a skin of the polymer covers the filler material and so that no filler material is exposed, and removing the skin to expose the filler material and a portion of the carbon to provide the fuel cell bipolar plate comprising carbon exposed at an outer surface of the bipolar plate.

11. A process as set forth in claim 1 wherein the function group is selected from the group consisting of R, OR, COR, COOR, OCOR, COOLi, COONa, COOK, COO⁻NR₄⁺, halogen, CN, NR₂, SO₃H, SO₃Li, SO₃Na, SO₃ K, SO₃⁻NR₄⁺, OSO₃H, OSO₃ salts, NR(COR), CONR₂, NO₂, PO₃H₂, PO₃ HNa, PO₃ Na₂, OPO₃ HNa, OPO₃ Na₂, N═NR, NR₃⁺X⁻, PR₃⁺X⁻, SₖR, SSO₃H, SSO₃⁻ salts, SO₂NRR′, SO₂ SR, SNRR′, SNQ, SO₂NQ, CO₂NQ, S-(1,4-piperazinediyl)-SR, 2-(1,3-dithianyl)2-(1,3-dithiolanyl), SOR, SO₂R, wherein R and R′, which can be the same or different, are independently hydrogen, branched or unbranched C₁-C₂₀ substituted or unsubstituted, saturated or unsaturated hydrocarbon, and wherein the integer k ranges from 1-8, the anion X⁻ is a halide or an anion derived from a mineral or organic acid, Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6.

12. A process as set forth in claim 1 wherein the functional group is an aromatic group.

13. A process as set forth in claim 1 wherein the functional group is an ionic or ionizable group.

14. A process as set forth in claim 1 wherein the functional groups is a quateronium group.

15. A process as set forth in claim 1 wherein the functional group is a quaternary ammonium or quaternary phosphonium group.

16. A process as set forth in claim 1 wherein the functional group is selected from the group consisting of (C₅H₄N)C₂H₅⁺, C₆H₄ (NC₅H₅)⁺, C₆H₄COCH₂N(CH₃)₃⁺, C₆H₄COCH₂(NC₅H₅)⁺, (C₅H₄N)CH₃⁺, and C₆H₄CH₂N(CH₃)₃⁺.

17. A product comprising:
a fuel cell bipolar plate comprising carbon, a portion of the carbon being located at an outer surface of the bipolar plate and a functional group attached only to the carbon located at the outer surface of the bipolar plate so that the hydrophilicity of the bipolar plate is increased where the functional group is attached.

18. A product as set forth in claim 17 wherein the bipolar plate is a composite plate comprising a polymer and a filler material comprising the carbon.

19. A product as set forth in claim 18 wherein the filler material comprises at least one of macroparticles, nanoparticles, fibers, nanofibers or nanotubes.

20. A product as set forth in claim 18 wherein the filler material comprises graphite.

21. A product as set forth in claim 17 wherein the bipolar plate a substrate comprising a metal or metal alloy, and a coating over the substrate, and wherein the coating comprises the carbon.

22. A product as set forth in claim 17 wherein the bipolar plate is a substrate comprising a metal or metal alloy, and a coating over the substrate, and wherein the coating comprising a polymer and a filler material, and wherein the filler material comprises the carbon.

23. A product as set forth in claim 22 wherein the filler material comprises at least one of macroparticles, nanoparticles, fibers, nanofibers or nanotubes.

24. A product as set forth in claim 17 wherein the function group is selected from the group consisting of R, OR, COR, COOR, OCOR, COOLi, COONa, COOK, COO⁻NR₄⁺, halogen, CN, NR₂, SO₃H, SO₃Li, SO₃Na, SO₃ K, SO₃⁻NR₄⁺, OSO₃H, OSO₃⁻ salts, NR(COR), CONR₂, NO₂, PO₃H₂, PO₃ HNa, PO₃ Na₂, OPO₃ HNa, OPO₃ Na₂, N═NR, NR₃⁺X⁻, PR₃⁺X⁻, SₖR, SSO₃H, SSO₃⁻ salts, SO₂NRR′, SO₂ SR, SNRR′, SNQ, SO₂NQ, CO₂NQ, S-(1,4-piperazinediyl)-SR, 2-(1,3-dithianyl)2-(1,3-dithiolanyl), SOR, SO₂R, wherein R and R′, which can be the same or different, are independently hydrogen, branched or unbranched C₁-C₂₀ substituted or unsubstituted, saturated or unsaturated hydrocarbon, and wherein the integer k ranges from 1-8, the anion X⁻ is a halide or an anion derived from a mineral or organic acid, Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6.

25. A product as set forth in claim 17 wherein the functional group is an aromatic group.

26. A product as set forth in claim 17 wherein the functional group is an ionic or ionizable group.

27. A product as set forth in claim 17 wherein the functional groups is a quateronium group.

28. A product as set forth in claim 17 wherein the functional group is a quaternary ammonium or quaternary phosphonium group.

29. A product as set forth in claim 17 wherein the functional group is selected from the group consisting of (C₅H₄N)C₂H₅⁺, C₆H₄(NC₅H₅)⁺, C₆H₄COCH₂N(CH₃)₃⁺, C₆H₄COCH₂(NC₅H₅)⁺, (C₅H₄N)CH₃⁺, and C₆H₄CH₂N(CH₃)₃⁺.

30. A process comprising:
dissolving a sulfanilic acid in a sodium carbonate solution, and adding sodium nitride thereto to form a first solution;
cooling the first solution to a temperature below 25° C. and adding hydrochloric acid to the cooled first solution to form a diazonium salt of the sulfanilic acid;
immersing a fuel cell bipolar plate comprising carbon into the cooled first solution and heating the first solution to a temperature above 25° C. and so that the diazonium salt reacts with the carbon to attach a functional group to the carbon thereby increasing the hydrophilicity of the bipolar plate where the function group is attached.

31. A process as set forth in claim 30 wherein the function group is selected from the group consisting of R, OR, COR, COOR, OCOR, COOLi, COONa, COOK, COO⁻NR₄⁺, halogen, CN, NR₂, SO₃H, SO₃Li, SO₃Na, SO₃ K, SO₃⁻NR₄⁺, OSO₃H, OSO₃⁻ salts, NR(COR), CONR₂, NO₂, PO₃H₂, PO₃HNa, PO₃Na₂, OPO₃ HNa, OPO₃ Na₂, N═NR, NR₃⁺X⁻, PR₃⁺X⁻, SₖR, SSO₃H, SSO₃⁻ salts, SO₂NRR′, SO₂ SR, SNRR′, SNQ, SO₂NQ, CO₂NQ, S-(1,4-piperazinediyl)-SR, 2-(1,3-dithianyl)2-(1,3-dithiolanyl), SOR, SO₂R, wherein R and R′, which can be the same or different, are independently hydrogen, branched or unbranched C₁-C₂₀ substituted or unsubstituted, saturated or unsaturated hydrocarbon, and wherein the integer k ranges from 1-8, the anion X⁻ is a halide or an anion derived from a mineral or organic acid, Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6.

32. A process as set forth in claim 30 wherein the functional group is selected from the group consisting of (C₅H₄N)C₂H₅⁺, C₆H₄ (NC₅H₅)⁺, C₆H₄COCH₂N(CH₃)₃⁺, C₆H₄COCH₂(NC₅H₅)⁺, (C₅H₄N)CH₃⁺, and C₆H₄CH₂N(CH₃)₃⁺.

33. A process comprising:
providing an electrolyte solution formed from a diazonium salt;
providing a working electrode comprising a bipolar plate comprising carbon, and providing a counter electrode and a reference electrode, and immersing the working electrode, counter electrode and reference electrode in the electrolyte solution;
applying a potential to the working electrode so that a radical of the diazonium salt reacts with the carbon to attach a functional group to the carbon thereby increasing the hydrophilicity of the bipolar plate where the function group is attached.

34. A process as set forth in claim 33 wherein the bipolar plate comprises a composite material comprising a polymer binder and a filler material comprising the carbon and wherein the filler material further comprises at least one of a fibers or particles.

35. A process as set forth in claim 34 wherein the composite material forms a skin covering the filler material at an outer surface of the bipolar plate and further comprising removing the skin to expose the filler material and the carbon prior to the immersing of the working electrode in the electrolyte solution.

36. A process as set forth in claim 33 wherein the providing an electrolyte solution formed from a diazonium salt comprises dissolving p-sulfanic pheyldiazonium tetrafluoroborate in a buffer solution.

37. A process as set forth in claim 33 wherein the function group is selected from the group consisting of R, OR, COR, COOR, OCOR, COOLi, COONa, COOK, COO⁻NR₄⁺, halogen, CN, NR₂, SO₃H, SO₃Li, SO₃Na, SO₃ K, SO₃⁻NR₄⁺, OSO₃H, OSO₃⁻ salts, NR(COR), CONR₂, NO₂, PO₃H₂, PO₃ HNa, PO₃Na₂, OPO₃HNa, OPO₃Na₂, N═NR, NR₃⁺X⁻, PR₃⁺X⁻, SₖR, SSO₃H, SSO₃⁻ salts, SO₂NRR′, SO₂SR, SNRR′, SNQ, SO₂NQ, CO₂NQ, S-(1,4-piperazinediyl)-SR, 2-(1,3-dithianyl)2-(1,3-dithiolanyl), SOR, SO₂R, wherein R and R′, which can be the same or different, are independently hydrogen, branched or unbranched C₁-C₂₀ substituted or unsubstituted, saturated or unsaturated hydrocarbon, and wherein the integer k ranges from 1-8, the anion X is a halide or an anion derived from a mineral or organic acid, Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6.

38. A process as set forth in claim 33 wherein the functional group is selected from the group consisting of (C₅H₄N)C₂H₅⁺, C₆H₄(NC₅H₅)⁺, C₆H₄COCH₂N(CH₃)₃⁺, C₆H₄COCH₂(NC₅H₅)⁺, (C₅H₄N)CH₃⁺, and C₆H₄CH₂N(CH₃)₃⁺.

39. A process as set forth in claim 33 wherein the diazonium salt is derived from a sulfanilic acid.

40. A process as set forth in claim 33 wherein the bipolar plate is a composite plate comprising a polymer and a filler material comprising the carbon.

41. A process as set forth in claim 40 wherein the filler material comprises at least one of macroparticles, nanoparticles, fibers, nanofibers or nanotubes.

42. A process as set forth in claim 40 wherein the filler material comprises graphite.

43. A process as set forth in claim 33 wherein the bipolar plate comprises a substrate comprising a metal or metal alloy, and a coating over the substrate, and wherein the coating comprises the carbon.

44. A process as set forth in claim 33 wherein the bipolar plate is a substrate comprising a metal or metal alloy, and a coating over the substrate, and wherein the coating comprising a polymer and a filler material comprising the carbon.

45. A process as set forth in claim 44 wherein the filler material comprises at least one of macroparticles, nanoparticles, fibers, nanofibers or nanotubes.
